(19) United States
(12) Patent Application Publication
(10) Pub. No.: US 2020/0163123 A1
(43) Pub. Date: May 21, 2020

(54) METHOD FOR PERFORMING RANDOM ACCESS PROCEDURE AND DEVICE SUPPORTING THE SAME

(71) Applicant: LG Electronics Inc., Seoul (KR)

(72) Inventors: Youngdae LEE, Seoul (KR); Sangwon KIM, Seoul (KR)

(21) Appl. No.: 16/631,071

(22) PCT Filed: Aug. 9, 2018
(86) PCT No.: PCT/KR2018/009061

§ 371 Date: Jan. 14, 2020

Related U.S. Application Data
(60) Provisional application No. 62/542,844, filed on Aug. 9, 2017.

(51) Int. Cl. H04W 74/08; H04W 76/27

(52) U.S. Cl. CPC H04W 74/0833; H04W 76/27

(57) ABSTRACT

Provided are a method of performing random access procedure and a device supporting the method. According to one embodiment of the present invention, a method for performing random access procedure in a wireless communication system includes: initiating a first random access procedure for system information (SI) request; triggering a state transition of the UE, before the first random access procedure is completed; stopping the first random access procedure; and initiating a second random access procedure for the state transition of the UE.

### BACKGROUND OF THE INVENTION

### Field of the Invention

The present invention relates to a wireless communication system, and more particularly, to a method for performing random access procedure efficiently and a device supporting the same.

### Related Art

Efforts have been made to develop an improved 5^{th}-generation (5G) communication system or a pre-5G communication system in order to satisfy a growing demand on radio data traffic after commercialization of a 4^{th}-generation (4G) communication system. A standardization act for a 5G mobile communication standard work has been formally started in 3GPP, and there is ongoing discussion in a standardization working group under a tentative name of a new radio access (NR).

Meanwhile, an upper layer protocol defines a protocol state to consistently manage an operational state of a user equipment (UE), and indicates a function and procedure of the UE in detail. In the discussion on the NR standardization, an RRC state is discussed such that an RRC_CONNECTED state and an RRC_IDLE state are basically defined, and an RRC_INACTIVE state is additionally introduced.

Meanwhile, System information (SI) is described. System information is divided into minimum SI and other SI. Minimum SI is periodically broadcast. The minimum SI comprises basic information required for initial access to a cell and information for acquiring any other SI broadcast periodically or provisioned via on-demand basis, i.e. scheduling information. The other SI encompasses everything not broadcast in the minimum SI.

### SUMMARY OF THE INVENTION

According to a prior art, in case that UE RRC triggers RACH procedure for SI request and then UE NAS triggers RRC Connection Establishment before completing the RACH procedure for SI request, the RACH procedure for SI request would delay state transition from IDLE to CONNECTED or from INACTIVE to CONNECTED.

According to one embodiment of the present invention, a method for performing, by a user equipment (UE), random access procedure in wireless communication system is provided. The method may comprise: initiating a first random access procedure for system information (SI) request; triggering a state transition of the UE, before the first random access procedure is completed; stopping the first random access procedure; and initiating a second random access procedure for the state transition of the UE.

The UE may be in one of radio resource control (RRC) inactive state or RRC idle state.

The state transition may be triggered by transmitting a RRC connection request message or a RRC connection resume message.

The state transition may be a transition from RRC idle state to RRC connected state.

The state transition may be a transition from RRC inactive state to RRC connected state.

The initiating the second random access procedure may include transmitting a message indicating the state transition to a network.

According to another embodiment of present invention, a user equipment (UE) in a wireless communication system is provided. The UE may comprise: a tranceiver for transmitting or receiving a radio signal; and a processor coupled to the transceiver, the processor configured to: initiate a first random access procedure for system information (SI) request; trigger a state transition of the UE, before the first random access procedure is completed; stop the first random access procedure; and initiate a second random access procedure for the state transition of the UE.

The UE may be in one of radio resource control (RRC) inactive state or RRC idle state.

The state transition may be triggered by transmitting a RRC connection request message or a RRC connection resume message.

The state transition may be a transition from RRC idle state to RRC connected state.

The state transition may be a transition from RRC inactive state to RRC connected state.

The processor may be configured to initiate the second random access procedure including transmitting a message indicating the state transition to a network.

### Advantageous Effects

According to embodiments of the present invention, the UE may prevent the delay of the RACH procedure for SI request, by stopping the ongoing RACH procedure for SI request and then trigger new RACH procedure for state transition, if UE triggers state transition procedure such as RRC Connection Establishment or RRC Connection Resume.

### BRIEF DESCRIPTION OF THE DRAWINGS

FIG. 1 shows an example of a wireless communication system to which technical features of the present invention can be applied.

FIG. 2 shows another example of a wireless communication system to which technical features of the present invention can be applied.

FIG. 3 shows a block diagram of a user plane protocol stack to which technical features of the present invention can be applied.

FIG. 4 shows a block diagram of a control plane protocol stack to which technical features of the present invention can be applied.

FIG. 5 illustrates reception of minimum SI and other SI

FIG. 6 shows an example of a method for performing random access procedure according to an embodiment of the present invention.

FIG. 7 shows an example of a method for performing random access procedure according to an embodiment of the present invention.

FIG. 8 shows a communication system to implement an embodiment of the present invention.

### DESCRIPTION OF EXEMPLARY EMBODIMENTS

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (DL). For example, only OFDMA may be used for DL and only SC-FDMA may be used for UL. Alternatively, OFDMA and SC-FDMA may be used for DL and/or UL.

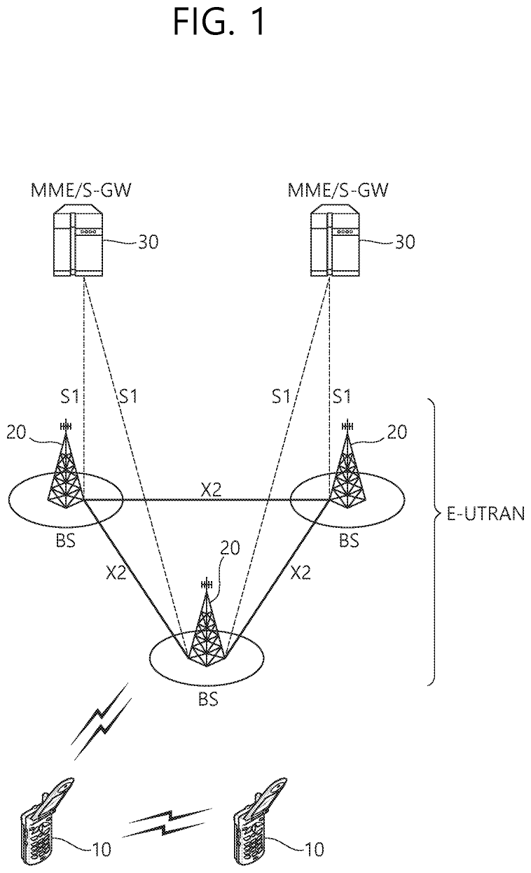

FIG. 1 shows an example of a wireless communication system to which technical features of the present invention can be applied. Specifically, FIG. 1 shows a system architecture based on an evolved-UMTS terrestrial radio access network (E-UTRAN). The aforementioned LTE is a part of an evolved-UTMS (e-UMTS) using the E-UTRAN.

Referring to FIG. 1, the wireless communication system includes one or more user equipment (UE; 10), an E-UTRAN and an evolved packet core (EPC). The UE 10 refers to a communication equipment carried by a user. The UE 10 may be fixed or mobile. The UE 10 may be referred to as another terminology, such as a mobile station (MS), a user terminal (UT), a subscriber station (SS), a wireless device, etc.

The E-UTRAN consists of one or more base station (BS) 20. The BS 20 provides the E-UTRA user plane and control plane protocol terminations towards the UE 10. The BS 20 is generally a fixed station that communicates with the UE 10. The BS 20 hosts the functions, such as inter-cell radio resource management (MME), radio bearer (RB) control, connection mobility control, radio admission control, measurement configuration/provision, dynamic resource allocation (scheduler), etc. The BS may be referred to as another terminology, such as an evolved NodeB (eNB), a base transceiver system (BTS), an access point (AP), etc.

A downlink (DL) denotes communication from the BS 20 to the UE 10. An uplink (UL) denotes communication from the UE 10 to the BS 20. A sidelink (SL) denotes communication between the UEs 10. In the DL, a transmitter may be a part of the BS 20, and a receiver may be a part of the UE 10. In the UL, the transmitter may be a part of the UE 10, and the receiver may be a part of the BS 20. In the SL, the transmitter and receiver may be a part of the UE 10.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 30 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 10 is connected to the BS 20 by means of the Uu interface. The UEs 10 are interconnected with each other by means of the PC5 interface. The BSs 20 are interconnected with each other by means of the X2 interface. The BSs 20 are also connected by means of the S1 interface to the EPC, more specifically to the MME by means of the S1-MME interface and to the S-GW by means of the S1-U interface. The S1 interface supports a many-to-many relation between MMES/S-GWs and BSs.

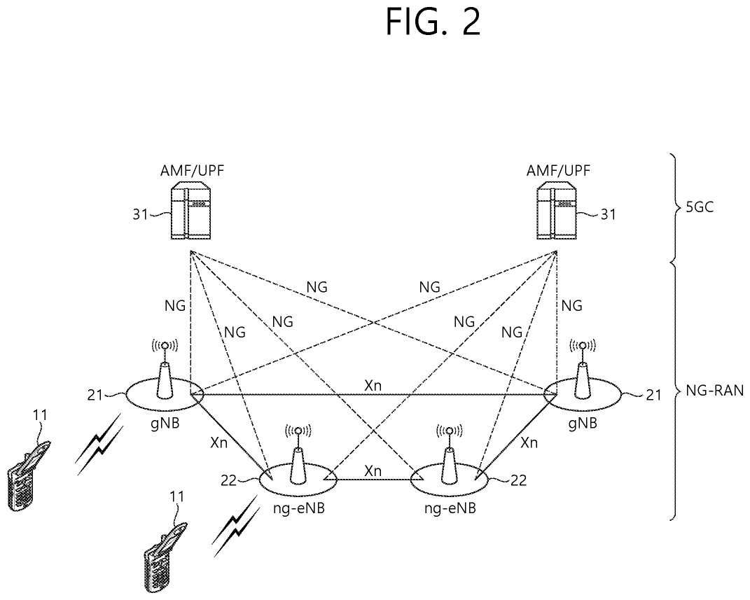

FIG. 2 shows another example of a wireless communication system to which technical features of the present invention can be applied. Specifically, FIG. 2 shows a system architecture based on a 5G new radio access technology (NR) system. The entity used in the 5G NR system (hereinafter, simply referred to as “NR”) may absorb some or all of the functions of the entities introduced in FIG. 1 (e.g. eNB, MME, S-GW). The entity used in the NR system may be identified by the name “NG” for distinction from the LTE/LTE-A.

Referring to FIG. 2, the wireless communication system includes one or more UE 11, a next-generation RAN (NG-RAN) and a 5th generation core network (5GC). The NG-RAN consists of at least one NG-RAN node. The NG-RAN node is an entity corresponding to the BS 10 shown in FIG. 1. The NG-RAN node consists of at least one gNB 21 and/or at least one ng-eNB 22. The gNB 21 provides NR user plane and control plane protocol terminations towards the UE 11. The ng-eNB 22 provides E-UTRA user plane and control plane protocol terminations towards the UE 11.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MIME. The UPF hosts the functions, such as mobility anchoring, protocol data unit (PDU) handling. The UPF an entity including the functions of the conventional S-GW. The SMF hosts the functions, such as UE IP address allocation, PDU session control.

The gNBs and ng-eNBs are interconnected with each other by means of the Xn interface. The gNBs and ng-eNBs are also connected by means of the NG interfaces to the 5GC, more specifically to the AMF by means of the NG-C interface and to the UPF by means of the NG-U interface.

A protocol structure between network entities described above is described. On the system of FIG. 1 and/or FIG. 2, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

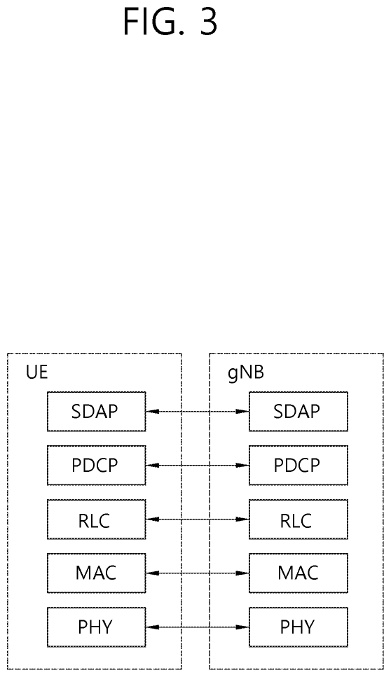

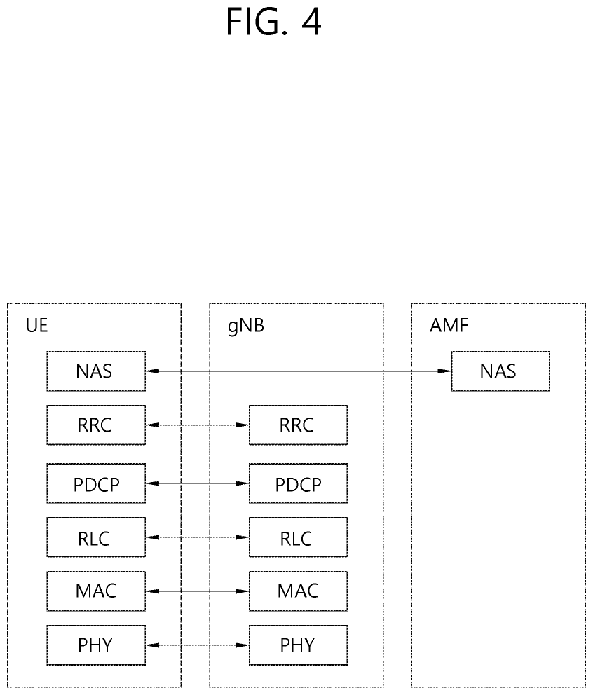

FIG. 3 shows a block diagram of a user plane protocol stack to which technical features of the present invention can be applied. FIG. 4 shows a block diagram of a control plane protocol stack to which technical features of the present invention can be applied. The user/control plane protocol stacks shown in FIG. 3 and FIG. 4 are used in NR. However, user/control plane protocol stacks shown in FIG. 3 and FIG. 4 may be used in LTE/LTE-A without loss of generality, by replacing gNB/AMF with eNB/MME.

Referring to FIG. 3 and FIG. 4, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARD), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the base station.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell. Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL. Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

System information (SI) is described. System information is divided into minimum SI and other SI. Minimum SI is periodically broadcast. The minimum SI comprises basic information required for initial access to a cell and information for acquiring any other SI broadcast periodically or provisioned via on-demand basis, i.e. scheduling information. The other SI encompasses everything not broadcast in the minimum SI.

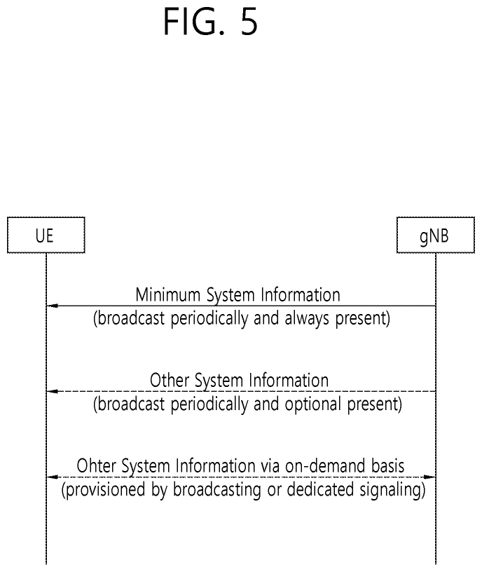

FIG. 5 illustrates reception of minimum SI and other SI. Referring FIG. 5, the other SI may either be broadcast, or provisioned in a dedicated manner, either triggered by the network or upon request from the UE. For the other SI required by the UE, before the UE sends the other SI request the UE needs to know whether it is available in the cell and whether it is broadcast or not. The UE in RRC_IDLE or RRC_INACTIVE should be able to request the other SI without requiring a state transition. For the UE in RRC_CONNECTED, dedicated RRC signaling can be used for the request and delivery of the other SI. The other SI may be broadcast at configurable periodicity and for certain duration. It is network decision whether the other SI is broadcast or delivered through dedicated UE specific RRC signaling.

Each cell on which the UE is allowed to camp broadcasts at least some contents of the minimum SI, while there may be cells in the system on which the UE cannot camp and do not broadcast the minimum SI. For a cell/frequency that is considered for camping by the UE, the UE should not be required to acquire the contents of the minimum SI of that cell/frequency from another cell/frequency layer. This does not preclude the case that the UE applies stored SI from previously visited cell(s). If the UE cannot determine the full contents of the minimum SI of a cell (by receiving from that cell or from valid stored SI from previous cells), the UE shall consider that cell as barred. It is desirable for the UE to learn very quickly that this cell cannot be camped on.

As described above, SI in NR may consist of Minimum SI and Other SI. Because gNB does not always broadcast Other SI, UE may request transmission of Other SI by triggering Random Access procedure. After completion of the Random Access procedure, UE receives Other SI according to the request.

In the prior art, UE should continue to perform the triggered Random Access procedure until the Random Access procedure is completed. RRC signaling is used for SI request in Msg3. On-demand SI request will be used at least by UEs in IDLE and UEs in INACTIVE. UE in IDLE or INACTIVE may request or activate a RRC connection by sending a RRC message such as a RRC Connection Request or RRC Connection Resume message.

There will be the case that UE RRC triggers RACH procedure for SI request and then UE NAS triggers RRC Connection Establishment before completing the RACH procedure for SI request. For example, if the SI request is a RRC message over CCCH, the RRC Connection Request message over CCCH can be transmitted only after the SI request is successfully transmitted and then UL resource is granted for the second RRC message. Thus, the RACH procedure for SI request would delay state transition from IDLE to CONNECTED or from INACTIVE to CONNECTED sometimes.

Hereinafter, a method for performing random access procedure according to an embodiment of present invention is described.

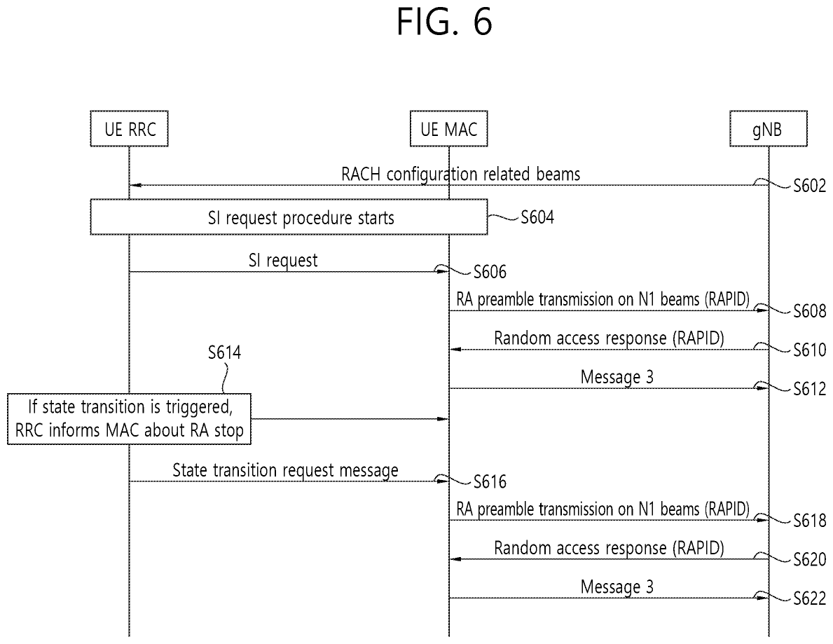

FIG. 6 shows an example of a method for performing random access procedure according to an embodiment of the present invention. According to an embodiment of present invention, if UE triggers state transition procedure such as RRC Connection Establishment or RRC Connection Resume, UE may stop ongoing RACH procedure for SI request and then trigger new RACH procedure for state transition.

In step S602, a RRC layer of UE may receive RACH configuration related to beams from gNB.

In step S604, the RRC layer of the UE may initiate SI request procedure for one or more System Information messages or one or more System Information Blocks.

In step S606, the RRC layer of the UE may submit a SI request message to a MAC layer. The UE may be in one of RRC_IDLE, RRC_INACTIVE and RRC_CONNECTED.

In step S608, the MAC layer of the UE may trigger the Random Access procedure to request Other SI. The MAC layer of the UE may transmit one of the Random Access Preambles.

The MAC layer may transmit random access preamble identity (RAPID) to gNB. The RAPID may correspond to the SI request.

In step S610, the MAC layer of the UE may receive random access response including RAPID from gNB.

In step S612, the MAC layer of the UE may transmit message 3 to gNB. The message 3 may carry the SI request.

In step S614, if the NAS layer of the UE requests state transition (e.g. the RRC Connection Establishment for state transition from RRC_IDLE to RRC_CONNECTED or the RRC Connection Resume from state transition from RRC_INACTIVE to RRC_CONNECTED) to the RRC layer of the UE, UE may initiate the RRC Connection Establishment or the RRC Connection Resume procedure. If the RRC layer of UE initiates RRC state transition such as the RRC Connection Establishment or the RRC Connection Resume procedure, the RRC layer of the UE may indicate stop of the triggered Random Access procedure to the MAC layer of the UE.

In step S616, the RRC layer may submit a state transition request message such as RRC Connection Request or RRC Connection Resume message to a MAC layer. If the RRC layer of the UE indicates stop of the triggered/ongoing Random Access procedure to the MAC layer of the UE before the initiated Random Access procedure is completed, the MAC layer of the UE stops the triggered Random Access procedure.

In step S618, MAC layer of UE may initiate another Random Access procedure to transmit the state transition request message.

In step S620, the MAC layer of the UE may receive random access response including RAPID from gNB.

In step S622, the MAC layer of the UE may transmit message 3 to gNB.

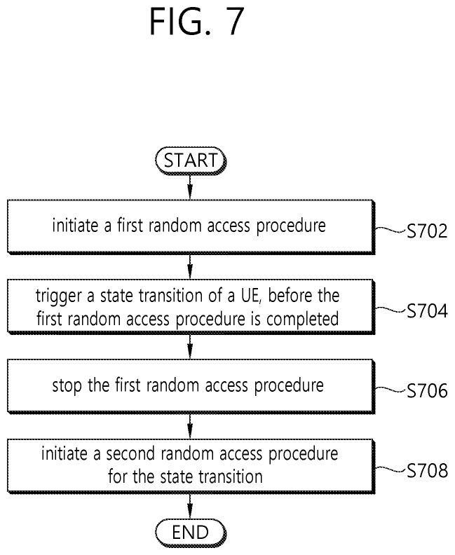

FIG. 7 shows an example of a method for performing random access procedure according to an embodiment of the present invention.

In step S702, the UE may initiate a first random access procedure for system information (SI) request. The UE may be in one of radio resource control (RRC) inactive state or RRC idle state.

In step S704, the UE may trigger a state transition of the UE, before the first random access procedure is completed. The state transition is triggered by transmitting a RRC connection request message or a RRC connection resume message. The state transition may be a transition from RRC idle state to RRC connected state. The state transition may be a transition from RRC inactive state to RRC connected state.

In step S706, the UE may stop the first random access procedure, if a state transition of the UE is triggered.

In step S708, the UE may initiate a second random access procedure for the state transition. The initiating the second random access procedure may include transmitting a message indicating the state transition to a network.

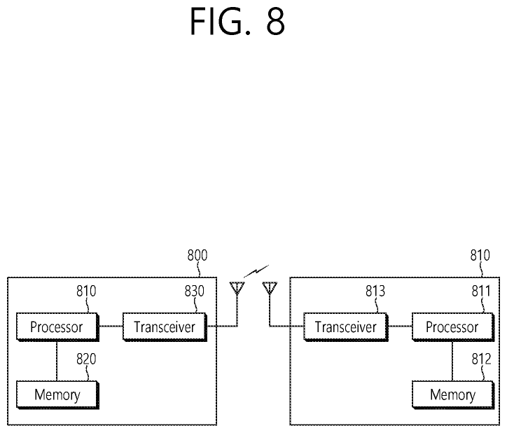

FIG. 8 shows a communication system to implement an embodiment of the present invention.

A UE 800 includes a processor 801, a memory 802, and a transceiver 803. The memory 802 is coupled to the processor 801, and stores a variety of information for driving the processor 801. The transceiver 803 is coupled to the processor 801, and transmits and/or receives a radio signal. The processor 801 implements the proposed functions, procedures, and/or methods. In the aforementioned embodiments, an operation of the first network node may be implemented by the processor 801.

A network node 810 includes a processor 811, a memory 812, and a transceiver 813. The memory 812 is coupled to the processor 811, and stores a variety of information for driving the processor 811. The transceiver 813 is coupled to the processor 811, and transmits and/or receives a radio signal. The processor 811 implements the proposed functions, procedures, and/or methods. In the aforementioned embodiments, an operation of the second network node 810 may be implemented by the processor 811.

The processors 811 may include application-specific integrated circuit (ASIC), other chipset, logic circuit and/or data processing device. The memories may include read-only memory (ROM), random access memory (RAM), flash memory, memory card, storage medium and/or other storage device. The transceivers may include baseband circuitry to process radio frequency signals. When the embodiments are implemented in software, the techniques described herein can be implemented with modules (e.g., procedures, functions, and so on) that perform the functions described herein. The modules can be stored in memories and executed by processors. The memories can be implemented within the processors or external to the processors in which case those can be communicatively coupled to the processors via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

1. A method for performing, by a user equipment (UE), random access procedure in wireless communication system, the method comprising:
initiating a first random access procedure for system information (SI) request;
triggering a state transition of the UE, before the first random access procedure is completed;
stopping the first random access procedure; and
initiating a second random access procedure for the state transition of the UE.

2. The method of claim 1, wherein the UE is in one of radio resource control (RRC) inactive state or RRC idle state.

3. The method of claim 1, wherein the state transition is triggered by transmitting a RRC connection request message or a RRC connection resume message.

4. The method of claim 1, wherein the state transition is a transition from RRC idle state to RRC connected state.

5. The method of claim 1, wherein the state transition is a transition from RRC inactive state to RRC connected state.

6. The method of claim 1, wherein the initiating the second random access procedure includes transmitting a message indicating the state transition to a network.

7. A user equipment (UE) in a wireless communication system, the UE comprising:
a transceiver for transmitting or receiving a radio signal; and
a processor coupled to the transceiver,
the processor configured to:
initiate a first random access procedure for system information (SI) request;
trigger a state transition of the UE, before the first random access procedure is completed;
stop the first random access procedure; and
initiate a second random access procedure for the state transition of the UE.

8. The UE of claim 7, wherein the UE is in one of radio resource control (RRC) inactive state or RRC idle state.

9. The UE of claim 7, wherein the state transition is triggered by transmitting a RRC connection request message or a RRC connection resume message.

10. The UE of claim 7, wherein the state transition is a transition from RRC idle state to RRC connected state.

11. The UE of claim 7, wherein the state transition is a transition from RRC inactive state to RRC connected state.

12. The UE of claim 7, wherein the processor is configured to initiate the second random access procedure including transmitting a message indicating the state transition to a network.

13. The method of claim 1, wherein the UE communicates with at least one of a mobile terminal, a network or autonomous vehicles other than the UE.
